(19) United States
(12) Patent Application Publication
(10) Pub. No.: US 2008/0080301 A1
(43) Pub. Date: Apr. 3, 2008

(54) Popsicle Machine for Home

(75) Inventors: Yang Cao, Shenzhen (CN); Zengfeng Chi, Shenzhen (CN); Shihui Xiong, Shenzhen (CN); Jianwei Liu, Shenzhen (CN)

Correspondence Address: GLOBAL IP SERVICES, 7285 W. Eagle Court, Winton, CA, 95388, US

(73) Assignee: SHENZHEN H & T ELECTRONIC TECHNOLOGY CO., LTD., Shenzhen (CN)

(21) Appl. No.: 11/841,523

(22) Filed: Aug. 20, 2007

(30) Foreign Application Priority Data
Sep. 28, 2006 (CN) 200610062927.3

(51) Int. Cl. B01F 15/00; B01F 15/06

(52) U.S. Cl. 366/142; 366/149

(57) ABSTRACT

The present invention relates to a home ice cream machine comprising a motor, a scratching card, a machine body, a refrigerant is equipped in the interlayer of the machine body, the scratching card is coupled with the motor and inserts into the machine body, the scratching card rotates in the machine body under the driving of the motor, the machine further comprises a MCU, the control output end of the MCU is attached to the input end of the motor, a corresponding time threshold value of ice cream production is preset inside of the MCU, when the time to switch on the motor reaches the preset threshold value, the MCIJ outputs a hold out signal to the motor. The ice cream machine of the present invention does not need the operator to carry on on-site control, when the producing of the ice cream finished, the MCU can switch off the motor automatically, the machine is not only user-friendly but also effective protection of the motor, thus increases the service life of the ice cream machine; and when operating the machine, once the producing of the ice cream is completed, the MCU will automatically start up the buzzer to ring to remind the user, makes it very convenient to the user.

### CROSS REFERENCE TO RELATED PATENT APPLICATION

This application claims the priority of the Chinese patent application No. 200610062927.3, its filing date is Sep. 28, 2006.

### FIELD OF THE INVENTION

The invention relates to a device for producing freezing sweetmeat, more particularly, relates to a home ice cream machine.

### BACKGROUND OF THE PRIOR ART

The home ice cream machine in the prior art generally includes a machine body, a scratching card, a motor to drive the scratching card to rotate, and a power switch, a refrigerant is equipped in the interlayer of the machine body. Usually in operation, there needs manually switch on/off the power of the machine, and needs individually estimate whether the production of ice cream has completed or not, such machine is very inconvenient in operation.

### SUMMARY OF THE INVENTION

In order to over the abovementioned defects of the home ice cream machine in the prior art, the present invention provided an automatic controllable home ice cream machine.

The technical solution of the present invention is to provide a home ice cream machine, which comprising a motor, a scratching card, a machine body, a refrigerant is equipped in the interlayer of the machine body, the scratching card is coupled with the motor and inserts into the machine body, the scratching card rotates in the machine body under the driving of the motor, wherein the machine further comprises a MCU, the control output end of the MCU is attached to the input end of the motor, the corresponding time threshold value of ice cream production is preset inside of the MCU, when the time to switch on the motor reaches the threshold value, the MCIJ outputs a hold out signal to the motor.

Advantageously, the home ice cream machine further comprises a cover, the handle of the scratching card passes through the central hole of the cover then couples with the motor.

Advantageously, the home ice cream machine also comprises an underdriving gear set that includes a first gear and a second gear that engaged with each other, the first gear is matching with the motor, the second gear is matching with the scratching card.

Advantageously, the home ice cream machine also includes a reed switch and a magnet, the reed switch is fixed on the cover, the magnet is inserted inside of the second gear, the output end of the reed switch is attached to the input end of the MCU; when the MCU receives a motor commutating signal or a motor locked signal that output from the reed switch, it will send a hold out signal to the motor.

Advantageously, the condition of the MCU receives the motor commutating signal that output from the reed switch is in the way that, the time for the reed switch to input two adjacent low levels to the MCU is longer than the longest time of the motor to rotate one circle or shorter than the shortest time of the motor to rotate one circle in normal condition.

Advantageously, the condition of the MCU receives the motor locked signal that output from the reed switch is in the way that, in a time unit, there's no variation occurred on the reed switch's low level outputs to the MCU, or the times of variation occurred on the reed switch's low level outputs to the MCU is surpasses the predetermined value.

Advantageously, the home ice cream machine also includes an alarm apparatus that attached to the MCU, while the MCU outputs the hold out signal to the motor, it starts up such alarm apparatus at the same time.

Advantageously, the alarm apparatus includes a liquid-crystal displayer, during the process of production ice cream, the alarm apparatus dynamically display the rotation of the scratching card, and when the MCU starts up the alarm apparatus, the liquid-crystal display will flash.

Advantageously, the alarm apparatus further includes a buzzer, when the MCU starts up the alarm apparatus, the buzzer will ring.

The beneficial effects of the invention comparing with the existing technology are, the ice cream machine of the present invention does not need the operator to carry on on-site control, when the producing of the ice cream finished, the MCU can switch off the motor automatically, the machine is not only user-friendly but also effective protection of the motor, thus increases the service life of the ice cream machine; and besides, when operating the machine of the invention, once the producing of the ice cream is completed, the MCU will automatically start up the buzzer to ring to remind the user, makes it very convenient to the user.

### BRIEF DESCRIPTION OF THE DRAWINGS

Explanation to the invention will be expatiated below by combining with the following figures and embodiments.

FIG. 1 is the schematic view of the structure of one embodiment, in accordance with the present invention;

FIG. 2 is the control diagram of the embodiment as in FIG. 1;

FIG. 3 is the schematic view of the structure of another embodiment, in accordance with the present invention;

FIG. 4 is the control diagram of the embodiment as in FIG. 3.

### DETAILED DESCRIPTION OF PREFERRED EMBODIMENT

### Example One

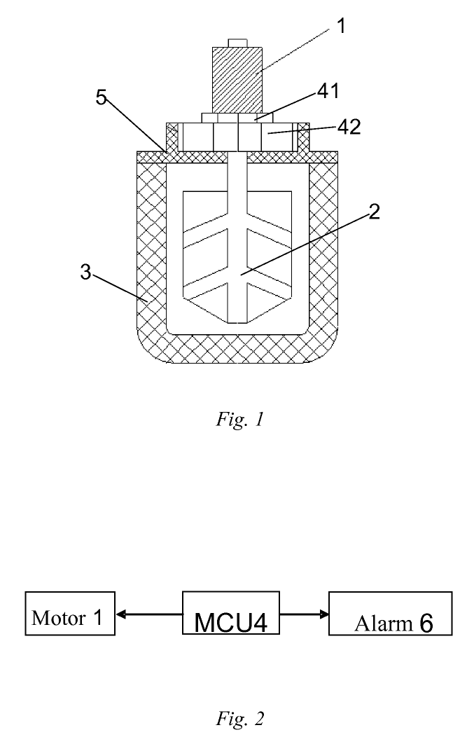

As shown in FIGS. 1 and 2, the home ice cream machine includes a motor 1, a scratching card 2, a machine body 3, and a MCU 4. The a refrigerant is equipped in the interlayer of the machine body 3, the scratching card 2 is coupled with the motor 1 and inserts into the machine body 3, the scratching card 2 rotates in the machine body 3 under the driving of the motor 1; the control output end of the MCU 4 is attached to the input end of the motor 1, the corresponding time threshold value of ice cream production is preset inside of the MCU 4, when the time to switch on the motor 1 reaches the threshold value, the MCU 4 outputs a hold out signal to the motor 1.

The working principle of the above said home ice cream machine is as below:

When producing ice cream, pour the ice cream rude liquid into the machine body 3, then start the motor 1, the motor 1 drives the scratching card 2 to rotate, when the time to switch on the motor 1 reaches the threshold value T, the MCU 4 outputs a hold out signal to the motor 1, the motor 1 then stops rotating, and the ice cream producing process completed.

In order to avoid excessive quick rotation of the scratching card 2, an underdriving gear set may be equipped between the motor 1 and the scratching card 2. The underdriving gear set includes a first gear 41 and a second gear 42 that engaged with each other, the first gear 41 is matching with the motor 1, the second gear 42 is matching with the scratching card 2. In operation, in order to avoid the ice cream rude liquid splashes out of the machine body 3, a cover 5 may be applied, the size of the cover 5 is equal to the machine body 3, a hole is set on the centre of the cover 5, the handle of the scratching card 2 passes through the central hole and coupled with the motor 1.

In order to operate facilely, an alarm apparatus 6 may be applied, the alarm apparatus 6 is connecting with the MCU 4. When the time to switch on the motor 1 reaches the threshold value T, the MCU 4 will launch the alarm apparatus 6. The alarm apparatus 6 includes a liquid crystal displayer 61, a buzzer 62, once the MCU 4 starting the alarm apparatus 6, the buzzer 62 will ring, and the liquid-crystal displayer 61 will flash to remind users.

### Example Two

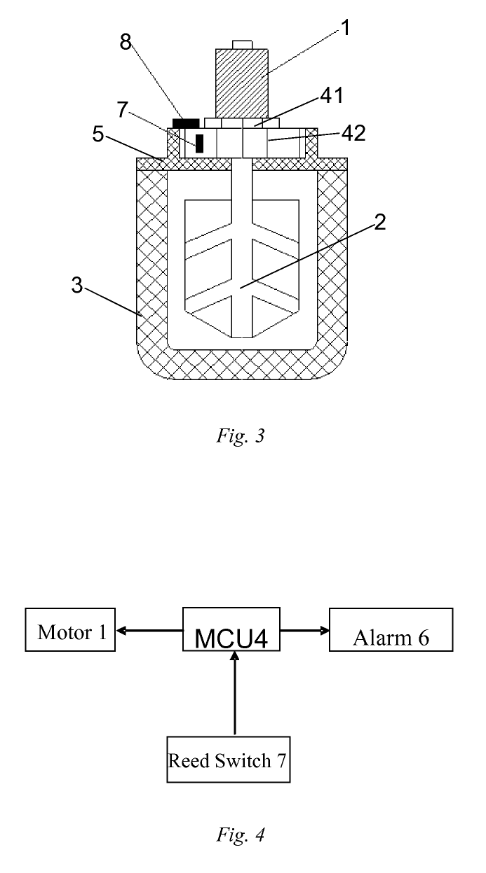

As shown in FIGS. 3 and 4, the difference between this embodiment and the embodiment in example one is:

a reed switch 7 and a magnet 8 are applied, the reed switch 7 is fixed on the cover 5, the magnet 8 is inserted inside the second gear 42, and the output end of the reed switch 7 is connected to the input end of the MCU. The status of commutating or locked rotation of the motor 1 can be detected by the level variation of the reed switch 7, once the commutating or locked rotation status is detected, the MCU 4 will output a hold out signal to the motor 1.

After starting the motor 1, the magnet 8 rotates evenly along with the second gear 42, the time of the magnet 8 rotate each circle should be constant, when the magnet 8 rotates close to the reed switch 7, the reed switch 7 shuts and outputs a low level to the MCU 4. If the magnet 8 does not rotate close to the reed switch 7, the reed switch 7 breaks off and outputs a high level to the MCU 4. Each time the second gear 42 rotates, the reed switch 7 closes one time, normally the time for two adjacent closes of the reed switch 7 is the same, that is to say, the time for the reed switch 7 to output two adjacent low levels to the MCU is the same.

The principle of detecting the abovementioned commutating and locked rotation of the motor 1 by the level variation of the reed switch 7 is as follow:

When the time for the reed switch 7 to input two adjacent low levels to the MCU 4 is longer than the upper limit or shorter than the lower limit, it means the motor 1 has changed its direction, the upper limit is the longest time for the motor 1 to rotate one circle in normal condition, and the lower limit is the shortest time for the motor 1 to rotate one circle in normal condition.

In a time unit, if no variation occurred on the reed switch's low level outputs to the MCU 4, or the times of variation occurred on the reed switch's low level outputs to the MCU 4 is surpasses the predetermined value, it means the locked rotation has occurred on the motor 1.

Once the motor's rotate direction changed or locked rotation occurred, the MCU 4 will start the alarm apparatus 6. The alarm apparatus 6 includes a liquid-crystal display 61, a buzzer 62, if the MCU 4 starts the alarm apparatus 6, the buzzer 62 will ring, and the liquid-crystal display 61 will flash to remind the operator.

Throughout the specification the aim has been to describe the preferred embodiment of the present invention without limiting the invention to any one embodiment or specific collection of features. Persons skilled in the relevant art may realize variations from the specific embodiment that will nonetheless fall within the scope of the invention.

What is claimed is:

1. A home ice cream machine comprising:
a motor, a scratching card, a machine body;
a refrigerant equipped in the interlayer of the machine body;
the scratching card being coupled with the motor and inserted into the machine body, the scratching card being driven to rotate in the machine body by the motor;
a MCU for automatically controlling the operation of the machine, a corresponding time threshold value of ice cream production is preset in the MCU, when the operating time of the motor reaches the preset threshold value, the MCU outputs a hold out signal to the motor.

2. The home ice cream machine as in claim 1, wherein further comprises a cover, a handle of the scratching card passes through the central hole of the cover and couples with the motor.

3. The home ice cream machine as in claim 2, wherein further comprises an underdriving gear set, the underdriving gear set includes a first gear and a second gear that engaged with each other, the first gear is matching with the motor, and the second gear is matching with the scratching card.

4. The home ice cream machine as in claim 3, wherein further comprises a reed switch and a magnet, the reed switch is fixed on the cover, the magnet is inserted inside of the second gear, the output end of the reed switch is attached to the input end of the MCU, when the MCU receives a motor commutating signal or a motor locked signal that output from the reed switch, it sends a hold out signal to the motor.

5. The home ice cream machine as in claim 4, wherein the condition of the motor commutating signal is that the interval time of two adjacent low levels exported to the MCU by the reed switch is longer than the longest time of the motor rotating one circle, or shorter than the shortest time of the motor rotating one circle in normal condition.

6. The home ice cream machine as in claim 4, wherein the condition of the motor locked signal is that low levels exported from the reed switch have no variation in a time unit, or have variation but the numbers of variation occurred in a time unit surpass the predetermined value.

7. The home ice cream machine as in claims 1, wherein further comprises an alarm apparatus attached to the MCU, the MCU outputs the hold out signal to the motor, it starts up the alarm apparatus at the same time.

8. The home ice cream machine as in claim 4, wherein further comprises an alarm apparatus attached to the MCU, the MCU outputs the hold out signal to the motor, it starts up the alarm apparatus at the same time.

9. The home ice cream machine as in claim 7, wherein the alarm apparatus comprises a liquid-crystal displayer, during a process of production ice cream the alarm apparatus dynamically display the rotation of the scratching card, and when the MCU starts up the alarm apparatus, the liquid-crystal display flashes.

10. The home ice cream machine as in claim 8, wherein the alarm apparatus comprises a liquid-crystal displayer, during a process of production ice cream the alarm apparatus dynamically display the rotation of the scratching card, and when the MCU starts up the alarm apparatus, the liquid-crystal display flashes.

11. The home ice cream machine as in claim 7, wherein the alarm apparatus further comprises a buzzer, when the MCU starts up the alarm apparatus, the buzzer rings.

12. The home ice cream machine as in claim 7, wherein the alarm apparatus further comprises a buzzer, when the MCU starts up the alarm apparatus, the buzzer rings.
